(19) United States
(12) Patent Application Publication
(10) Pub. No.: US 2026/0360005 A1
(43) Pub. Date: Nov. 12, 2026

(54) POSE DETERMINATION METHOD, POSE DETERMINATION DEVICE, ELECTRONIC DEVICE, COMPUTER-READABLE STORAGE MEDIUM, AND COMPUTER PROGRAM PRODUCT

(71) Applicant: UBTECH ROBOTICS CORP LTD, Shenzhen (CN)

(72) Inventors: SHUPING HU, Shenzhen (CN); Mingqi Gao, Shenzhen (CN); Pei Dong, Shenzhen (CN); Jianxin Pang, Shenzhen (CN); Jichao Jiao, Shenzhen (CN)

(21) Appl. No.: 19/375,276

(22) Filed: Oct. 31, 2025

(30) Foreign Application Priority Data
Dec. 26, 2024 (CN) 202411965429.4

(51) Int. Cl. G06T 7/73; B25J 9/16; B25J 19/02; G06T 7/50

(52) U.S. Cl. CPC G06T 7/73; B25J 9/1664; B25J 9/1669; B25J 9/1697; B25J 19/023; G06T 7/50; G06T 2207/10028

(57) ABSTRACT

A pose determination method, a pose determination device, an electronic device, a computer-readable storage medium, and a computer program product are provided. The pose determination method includes: acquiring an image to be recognized and a depth image corresponding to the image to be recognized, wherein the image to be recognized includes at least one target object; determining, from the image to be recognized, an region image corresponding to a first surface of the at least one target object; determining point cloud data of the region image based on the region image and the depth image; determining plane information and boundary information of the first surface of the at least one target object based on each point cloud data; and determining pose information of the at least one target object based on the plane information and the boundary information.

### CROSS-REFERENCE TO RELATED APPLICATION

The present disclosure claims foreign priority to Chinese Patent Application No. CN202411965429.4, titled “POSE DETERMINATION METHOD, POSE DETERMINATION DEVICE, ELECTRONIC DEVICE, COMPUTER-READABLE STORAGE MEDIUM, AND COMPUTER PROGRAM PRODUCT”, filed on Dec. 26, 2024 in China National Intellectual Property Administration., and the entire contents of which are hereby incorporated by reference.

### TECHNICAL FIELD

The present disclosure relates to a field of pose determination technology, and in particular to a pose determination method, a pose determination device, an electronic device, a computer-readable storage medium, and a computer program product.

### BACKGROUND

When a robot carries an object such as a box, the robot needs to use a red, green, blue (RGB) image and a depth image collected by a sensor to estimate a pose of the box, so the robot is allowed to successfully grip and carry the box. However, in a process of estimating the pose of the box, due to the limitations of the sensor itself, when a camera is too close to the box or the box is exposed to sunlight, a large amount of depth information of the box is unable to be acquired, which in turn leads to inaccurate estimation of the pose of the box and even inability to estimate the pose of the box.

### SUMMARY

Embodiments of the present disclosure provide a pose determination method, a pose determination device, an electronic device, a computer-readable storage medium, and a computer program product, which improve reliability and accuracy of pose determination.

The present disclosure provides a pose determination method. The pose determination method includes steps:
acquiring an image to be recognized and a depth image corresponding to the image to be recognized, wherein the image to be recognized includes at least one target object;
determining, from the image to be recognized, a region image corresponding to a first surface of the at least one target object;
determining point cloud data of the region image based on the region image and the depth image;
determining plane information and boundary information of the first surface of the at least one target object based on each point cloud data; and
determining pose information of the at least one target object based on the plane information and the boundary information.

The present disclosure further provides a pose determination device. The pose determination device includes an acquisition module and a determination module. The acquisition module is configured to acquire an image to be recognized and a depth image corresponding to the image to be recognized, wherein the image to be recognized includes at least one target object. The determination module is configured to: determine from the image to be recognized, a region image corresponding to a first surface of the at least one target object; determine point cloud data of the region image based on the region image and the depth image; determine plane information and boundary information of the first surface of the at least one target object based on each point cloud data; and determine pose information of the at least one target object based on the plane information and the boundary information.

The present disclosure further provides an electronic device. The electronic device includes a memory and a processor. The memory is configured to store computer-executable instructions or computer programs. The processor is configured to implement the pose determination method described above when executing the computer-executable instructions or the computer programs stored in the memory.

The present disclosure further provides a computer-readable storage medium. The computer-readable storage medium includes computer-executable instructions or computer programs stored thereon. The computer-executable instructions or the computer programs are executed by a processor to implement the pose determination method described above.

The present disclosure further provides a computer program product. The computer program product includes computer-executable instructions or computer programs. The computer-executable instructions or the computer programs are executed by a processor to implement the pose determination method described above.

In the embodiments of the present disclosure, the image to be recognized and the depth image corresponding to the image to be recognized are acquired, where the image to be recognized includes the at least one target object. Then, the region image corresponding to the first surface of the at least one target object is determined from the image to be recognized, the point cloud data of the region image is determined based on the region image and the depth image, the plane information and the boundary information of the first surface of the at least one target object are determined based on each point cloud data, and the pose information of the at least one target object is determined based on the plane information and the boundary information. Specifically, by determining the point cloud data of the region image based on the region image and the depth image, the point cloud data is enriched. The point cloud data is enriched to improve the reliability and accuracy of determining the plane information and the boundary information of the first surface of the at least one target object, thereby improving the reliability and accuracy of determining the pose information. Moreover, by determining the plane information and the boundary information of the first surface of the at least one target object through plane fitting, spatial information of the first surface of the at least one target object is accurately recognized, thereby improving the accuracy of determining the pose information of the at least one target object. In addition, since the pose information is determined only by the first surface of the at least one target object in the present disclosure, integrity requirements for the image to be recognized are low, which expands an application scope of the pose determination method. Therefore, the embodiments of the present disclosure improve the reliability and accuracy of pose determination and improve the application scope of the pose determination method.

### BRIEF DESCRIPTION OF DRAWINGS

FIG. 1 is a schematic diagram of an architecture of a pose determination system according to one embodiment of the present disclosure.

FIG. 2 is a block diagram of a terminal according to one embodiment of the present disclosure.

FIG. 3A is a flow chart of a pose determination method according to one embodiment of the present disclosure.

FIG. 3B is a flow chart of determining point cloud data according to one embodiment of the present disclosure.

FIG. 3C is a flow chart of determining plane information and boundary information according to one embodiment of the present disclosure.

FIG. 3D is a flow chart of determining coordinates of corner points according to one embodiment of the present disclosure.

FIG. 3E is a flow chart of determining a second supplementary point cloud according to one embodiment of the present disclosure.

FIG. 3F is a flow chart of determining a moving target object according to one embodiment of the present disclosure.

FIG. 4 is a schematic diagram of a carton structure according to one embodiment of the present disclosure.

FIG. 5 is a schematic diagram of an image to be recognized according to one embodiment of the present disclosure.

### DETAILED DESCRIPTION

In order to make the objectives, technical solutions, and characteristics of the present disclosure clear, the present disclosure is described in detail with reference to the accompanying drawings, and the described embodiments are not considered as limitations to the present disclosure, and all other embodiments acquired by those skilled in the art without creative efforts shall fall within the protection scope of the present disclosure.

In the description of the present disclosure, reference is made to “some embodiments”, which describe a subset of all possible embodiments, but it is to be understood that“ some embodiments” may be the same subset or different subsets of all possible embodiments and may be combined with each other without conflict.

In the description of the present disclosure, the terms “first”, “second”, and “third” involved are for distinguishing similar objects, and do not represent a specific order for the similar objects. It is understood that the terms “first”, “second”, and “third” may be interchanged with a particular order or sequence when allowed, so that the embodiments of the present disclosure described herein can be implemented in an order other than illustrated or described herein.

In the embodiments of the present disclosure, the term “module” or “unit” refers to a computer program or a part of a computer program having a predetermined function, and works with other related parts to implement a predetermined target, and may be implemented completely or partially by using software, hardware (for example, a processing circuit or a memory), or a combination thereof. Similarly, a processor (or a plurality of processors or memories) may be configured to implement one or more modules or units. In addition, each module or each unit may be a part of an overall module or an overall unit having functions of each module or each unit.

Unless otherwise defined, all technical terms and scientific terms used in the embodiments of the present disclosure have the same meaning as commonly understood by those skilled in the art. Terms used in the embodiments of the present disclosure are merely intended to describe objectives of the embodiments of the present disclosure, and are not intended to limit the present disclosure.

In the embodiments of the present disclosure, when data collection processing is applied to the instance application, it should strictly follow the requirements of related laws and regulations to acquire the informed consent or separate consent of the personal information subject, and subsequent data use and processing should be carried out within the scope of authorization of the related laws and regulations and the personal information subject.

Before further describing the embodiments of the present disclosure in detail, the terms involved in the embodiments of the present disclosure are explained. The terms involved in the embodiments of the present disclosure are subject to the following interpretations.
1) RGB (red, green, and blue): image represents color image format consisting of three channels, where each pixel thereof consists of three-color components respectively corresponding to red, green, and blue. A value of each color component commonly ranges from 0 to 255, indicating an intensity of the color.
2) RGBD (RGB depth) image is a color image format consisting of four channels, where RGB channels represent red, green, and blue color components in the RGBD image, and a depth channel represents depth information corresponding to each pixel and indicates a distance of each pixel from a camera.
3) Depth image is an image format that records distance information of a distance from each pixel in the depth image to a depth camera or a sensor. The depth image is commonly captured by the depth camera or the sensor. The depth image does not provide color information, but instead provides a grayscale image where a grayscale value of each pixel represents the distance from the pixel to the depth camera.
4) Two dimension to three dimension 2D-3D pose estimation is a process of inferring a 3D spatial position and an orientation of an object from a 2D image or an image sequence by using computer vision technology. A goal of the 2D-3D pose estimation is to determine a pose of the object in 3D space, which includes a position (generally expressed as x, y, z coordinates) and an orientation (generally expressed as a rotation matrix, Euler angles, or quaternions).
5) Pose refers to the position and the orientation of the object in the 3D space. The position of the object refers to a specific location of the object in the 3D space, which is commonly expressed by 3D coordinates (x, y, z). The orientation of the object refers to a direction of the object, which is expressed by various mathematical representations, such as rotation matrix, Euler angles, or the quaternions.
6) Instance segmentation mask refers to a segmentation technique that accurately segments an outline or a region of each individual object in an image.

In related art, to enable a robot to move boxes, a visual algorithm is applied to determine a pose of a box to be moved in a coordinate system of the robot. Common pose estimation algorithms are categorized as those based on the RGB images and those based on the RGBD images.

The pose estimation algorithms based on the RGB images rely on a pre-built 3D object model and require relatively rich object texture. The pose estimation algorithms based on the RGB images estimate the pose of the object through a combination of feature point matching and 2D-3DPnP methods. However, in a case of box moving, the box itself lacks texture, making the pose estimation algorithms based on the RGB images unsuitable.

The pose estimation algorithms based on the RGBD images rely on the depth information and are performed by a point cloud matching method. Because the pose estimation algorithms based on the RGBD images rely heavily on the integrity of the depth information, the point cloud matching method fails when the depth information is severely missing. In practice, depth information loss easily occurs due to factors such as a camera of the robot being too close to the box when the robot is moving the box (the box is not within an operating range of the camera), a working environment being outdoors (where sunlight interferes with the depth information), or the box being black (which absorbs significant light and causes depth information loss). As a result, the pose estimation of the pose estimation algorithms based on the RGBD images is inaccurate or even the pose estimation is unable to be performed.

Embodiments of the present disclosure provide a pose determination method, a pose determination device, an electronic device, a computer-readable storage medium, and a computer program product, which improve reliability and accuracy of pose determination.

The following describes exemplary applications of the electronic devices of the embodiments of the present disclosure. The electronic device of the embodiments of the present disclosure is selected from various types of terminals, such as an intelligent robot (such as a logistics handling robot or an industrial robot), a laptop, a tablet computer, a desktop computer, a set-top box, a smart phone, a smart speaker, a smart watch, a smart TV, and an in-vehicle terminal Of course, the electronic device may be a server. The following describes an exemplary application where the electronic device is a terminal.

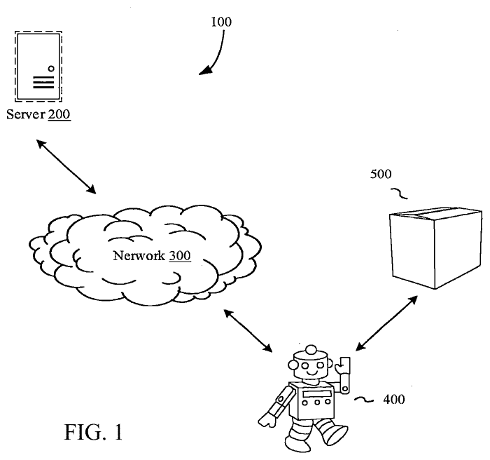

FIG. 1 is a schematic diagram of an architecture of a pose determination system 100 according to one embodiment of the present disclosure. As shown in FIG. 1, the terminal 400 is connected to the server 200 via a network 300. The network 300 may be a wide region network (WAN) or a local region network (LAN), or a combination thereof.

The terminal 400 is a target device such as an unmanned vehicle, a drone, a robot, or an aircraft. When the target object 500 needs to be delivered, the terminal 400 is configured to acquire an image to be recognized and a depth image corresponding to the image to be recognized, determine, from the image to be recognized, a region image corresponding to a first surface of the at least one target object; determine point cloud data of the region image based on the region image and the depth image; determine plane information and boundary information of the first surface of the at least one target object based on each point cloud data; and determine pose information of the at least one target object based on the plane information and the boundary information. Then, based on the pose information of the at least one target object 500, the target device is controlled to grip the target object 500 and carry it.

Alternatively, when the at least one target object 500 needs to be delivered, the terminal 400 uses the camera or the sensor disposed on the head thereof to capture the image to be recognized and the depth image corresponding to the image to be recognized, and then transmits the image to be recognized and the depth image to the server 200. The server 200 receives the image to be recognized and the depth image, and determines, from the image to be recognized, the region image corresponding to the first surface of the target object 500; for the region image, determines the point cloud data of the region image based on the region image and the depth image; determines the plane information and the boundary information of the first surface based on the point cloud data; and determines the pose information of the target object 500 based on the plane information and the boundary information. The server 200 then controls the target device to grip and carry the target object 500 based on the pose information of the at least one target object 500. Alternatively, the server 200 transmits the pose information to the terminal 400, and the terminal 400 controls the target device to grip and deliver the at least one target object 500 based on the pose information of the at least one target object 500.

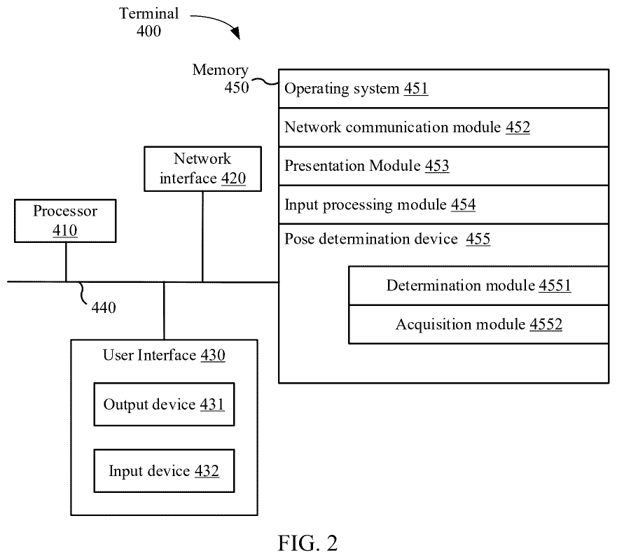

Taking the electronic device configured to perform the pose determining method is the terminal as an example. As shown in FIG. 2, FIG. 2 is a block diagram of the terminal according to one embodiment of the present disclosure. The terminal 400 includes at least one processor 410, a memory 450, at least one network interface 420, and a user interface 430. The various components in the electronic device are coupled together through a bus system 440. It is understood that the bus system 440 is configured to realize the connection and communication between the various components. In addition to a data bus, the bus system 440 further includes a power bus, a control bus, and a status signal bus. However, for ease of illustration, various buses are included in the bus system 440 shown in FIG. 2.

The at least one processor 410 may be an integrated circuit chip having a signal processing capability, such as a general-purpose processor, a digital signal processor (DSP), or a programmable logic device, a discrete gate, or a transistor logic device, a discrete hardware component, etc. The general-purpose processor is a microprocessor or any conventional processor, etc.

The user interface 430 includes at least one output device 431 configured to display media content. The at least one output device 431 includes one or more speakers and one or more visual display screens. The user interface 430 further includes at least one input device 432. The at least one input device 432 includes user interface components that facilitate user input, such as a keyboard, a mouse, a microphone, a touch screen display, a camera, other input buttons, and control pieces.

The memory 450 may be removable, non-removable, or a combination thereof. For instance, the memory 450 may be a hardware device, such as a solid-state memory, a hard disk drive, an optical drive, etc. Optionally, the memory 450 includes one or more storage devices physically located away from the at least one processor 410.

The memory 450 may include a volatile memory or a non-volatile memory, and may further include both the volatile memory and the non-volatile memory. The non-volatile memory may be a read-only memory (ROM), and the volatile memory may be a random access memory (RAM). The memory 450 described in the embodiments of the present disclosure is intended to include any suitable type of memory.

In some embodiments, the memory 450 is capable of storing data to support various operations, examples of which include programs, modules, and data structures or subsets or supersets thereof, as exemplified below.

An operating system 451 thereof includes system programs configured to process various basic system services and perform hardware-related tasks, such as a framework layer, a core library layer, a driver layer, etc. The operating system 451 is further configured to realize various basic services and processing hardware-based tasks.

A network communication module 452 thereof is configured to communicate with other electronic devices via the at least one (wired or wireless) network interfaces 420. For instance, the at least one network interface 420 includes a BLUETOOTH module, a wireless compatibility certification (WIFI), and a universal serial bus (USB).

A presentation module 453 thereof is configured to present information via the at least one output device 431 (e.g., a display screen, the speakers, etc.) associated with the at least one user interface 430 (e.g., a user interface configured to control an external device and display content and information).

An input processing module 454 is configured to detect one or more user inputs or interactions from the at least one input device 432 and translate detected one or more user inputs or interactions.

In some embodiments, the pose determination device in the embodiments of the present disclosure may be implemented in a software manner, and FIG. 2 shows the pose determination device 455 stored in the memory 450. The pose determination device 455 may be a software in a form such as a program and a plugin. The pose determination device 455 includes an acquisition module 4551 and a determination module 4552. These modules are logical and are able to be combined or further split according to functions to be implemented. Functions of these modules are described below.

In some other embodiments, the pose determination device in the embodiments of the present disclosure may be implemented in a manner of hardware. For instance, the pose determination device in the embodiments of the present disclosure is a hardware decoding processor, and the hardware decoding processor is programmed to perform the image processing method of the present disclosure. For instance, the hardware decoding processor includes one or more application specific integrated circuits (ASICs), a digital signal processor (DSP), a programmable logic device (PLD), a complex programmable logic device (CPLD), a field-programmable gate array (FPGA), or other electronic components.

The pose determination method provided by the embodiments is described in conjunction with exemplary applications and implementations of the terminal provided by the embodiments.

The following describes the pose determination method of the embodiments. As previously mentioned, the electronic device implementing the pose determination method of the embodiments is the terminal, the server, or a combination of the two. Therefore, the following description does not repeatedly describe the execution entity of steps.

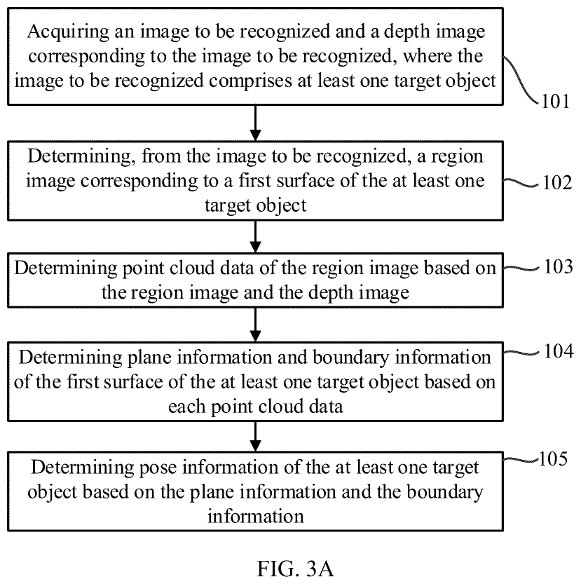

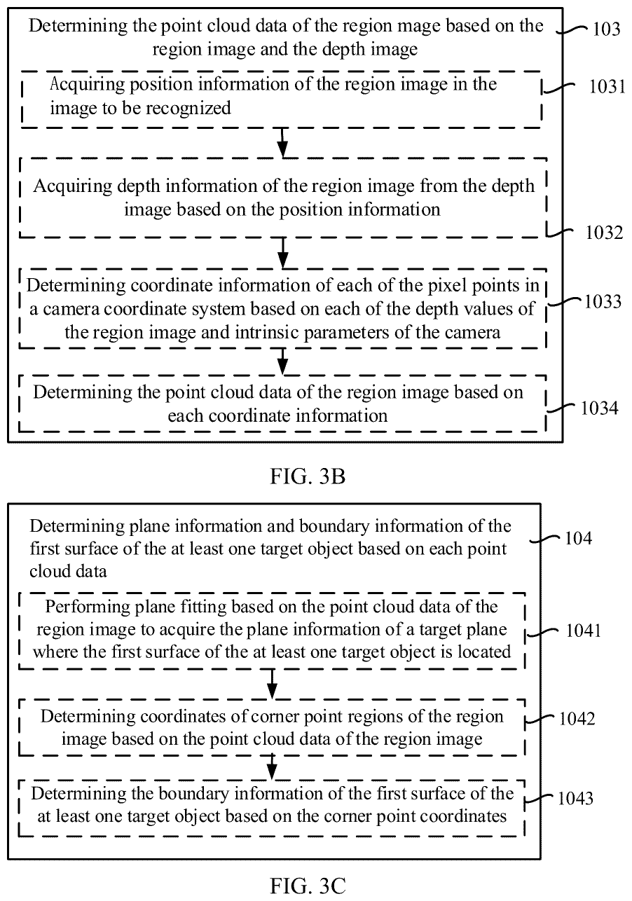

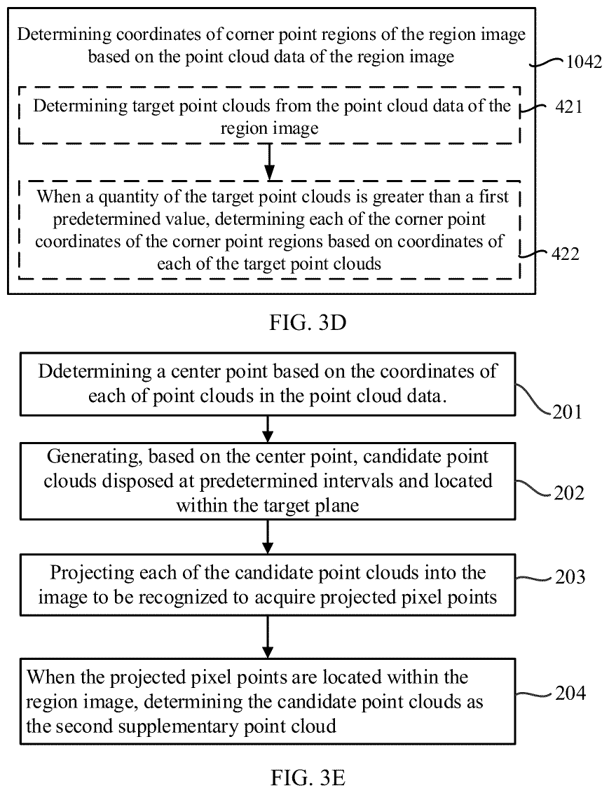

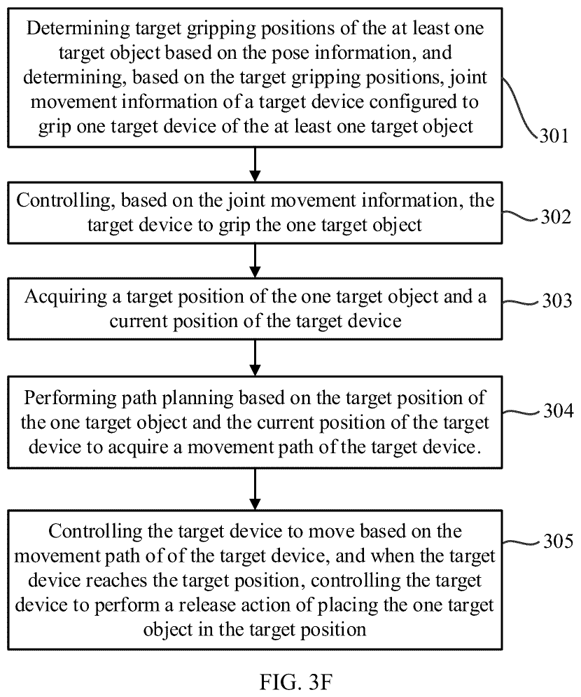

FIG. 3A is a flow chart of the pose determination method according to one embodiment of the present disclosure. The pose determination method including steps S101-106 is described in conjunction with the steps shown in FIG. 3A.

As shown in FIG. 3A, the step 101 includes acquiring an image to be recognized and a depth image corresponding to the image to be recognized, wherein the image to be recognized includes at least one target object.

In the embodiment, the camera captures the image to be recognized. The image to be recognized is generally an RGB image containing color information. Furthermore, the image to be recognized includes at least one target object, which is generally a regularly shaped object (such as a rectangular or cubed object), such as a box, furniture, or a book. The depth image corresponds to the image to be recognized and is acquired by a camera with depth perception capability or a sensor with depth perception capability. The depth image includes depth information of each of pixel points in the image to be recognized. To ensure accurate correspondence between the image to be recognized and the depth image, the camera or the sensor captures the image to be recognized and the depth image synchronously and ensures the image to be recognized and the depth image are aligned in time. Furthermore, basic preprocessing is performed on the image to be recognized, such as adjusting brightness and contrast or filtering and denoising, to improve image quality. The depth images may include noise or inaccurate depth values. A filtering algorithm, such as bilateral filtering or median filtering, is applied to remove noise and smooth the depth information.

The step 102 includes determining, from the image to be recognized, a region image corresponding to a first surface of the at least one target object.

The first surface is generally an upper surface of the at least one target object. Taking the at least one target object as a rectangular box as an example, the first surface is a top surface of the box. The region image is an image region corresponding to the first surface. That is, the region image only includes the first surface of one of the at least one target object. Since the image to be recognized may include at least one target object (i.e., one or more target objects), and each target object has a corresponding first surface, the image to be recognized may include a plurality of region images. Specifically, sample images including target objects are acquired in advance, and first surfaces of the target objects in the sample images are marked one by one in a form of instance masks. A training set is constructed by batches of marked sample images, and then a model is trained by using the training set to acquire a segmentation model for recognizing the first surface of each target object. In this way, the first surface of each target object in the image to be recognized is directly segmented out separately by the segmentation model to acquire each region image.

The step 103 includes determining point cloud data of the region image based on the region image and the depth image.

In the embodiment, taking one region image as an example, the point cloud data includes coordinates of pixel points in the region image in three-dimensional space (commonly x, y, and z), and may further include other information such as color, intensity, or texture coordinates. By aligning the region image and the depth image to ensure that the region image and the depth image are spatially aligned, so that the depth information is associated with the pixel points of the region image. Depth values one-to-one corresponding to the pixel points in the region image are then converted into point coordinates in three-dimensional space to acquire the point cloud data. Specifically, the depth image commonly provides a mapping relationship from the pixel points to the three-dimensional space, and the mapping relationship is directly applied to convert the depth values into the point cloud data.

In some embodiments, as shown in FIG. 3B, the step 103 is achieved by steps 1031-1034.

The step 1031 includes acquiring position information of the region image in the image to be recognized.

Taking one region image as an example, since the region image is segmented from the image to be recognized, the region image has a corresponding position in the image to be recognized. The position of the region image in the image to be recognized is demarcated by using a bounding box, and the position of the region image is configured as the position information. Alternatively, coordinates of corner point regions of the region image are configured as the position information of the region image in the image to be recognized.

The step 1032 includes acquiring depth information of the region image from the depth image based on the position information.

Taking one region image as an example, since the image to be recognized and the depth image are allowed to be aligned, the position of the region image in the depth image is determined based on the position of the region image in the image to be recognized. The depth information corresponding to the region image in the depth image is then used as the depth information of the region image. Therefore, the depth information includes the depth values of the pixel points in the region image.

The step 1033 includes determining coordinate information of each of the pixel points in a camera coordinate system based on each of the depth values of the region image and intrinsic parameters of the camera.

The intrinsic parameters of the camera include a focal length and principal point coordinates. The intrinsic parameters of the camera describe the geometric characteristics of camera imaging. The camera coordinate system is centered at an optical center of the camera, an x-axis thereof is a horizontal direction along the camera/sensor, a y-axis thereof is a vertical direction along the camera/sensor, and a z-axis thereof is from the optical center toward a front of the camera. The z-axis represents an imaging direction. The coordinates of each of the pixel points are converted to physical coordinates in an image coordinate system. By mapping depth values of the pixels points to the intrinsic parameters of the camera, a position of physical coordinates of each of the pixel points in the camera coordinate system is calculated, yielding the coordinate information of each of the pixel points in the camera coordinate system.

The step 1034 includes determining the point cloud data of the region image based on each coordinate information.

Specifically, all of the coordinate information of the pixel information is combined together to serve as the point cloud data of the region image. Alternatively, all of the coordinate information is further combined with other information such as color and texture coordinates to form the point cloud data of the region image.

In the embodiment, the position information of the region image in the image to be recognized is acquired, the depth information of the region image is acquired from the depth image based on the position information, the coordinate information of each of the pixel points in the camera coordinate system is determined based on each of the depth values of the region image and the intrinsic parameters of the camera, and the point cloud data of the region image is determined based on each coordinate information. In this way, by converting the depth information of the region image into the point cloud data, the position of the first surface of the at least one target object relative to the camera is intuitively represented, thereby facilitating the determination of the pose information of the at least one target object based on the first surface of the at least one target object and improving the reliability and accuracy of the pose determination.

The step 104 includes determining plane information and boundary information of the first surface of the at least one target object based on each point cloud data.

Taking one target object as an example, the plane information is configured to determine a plane where the first surface lies, and the boundary information is configured to determine an edge of the first surface of the target object. The plane information is a plane equation, that is, a mathematical expression of the plane where the first surface lies in the camera coordinate system. The boundary information is a line segment equation, that is, a mathematical expression of a line segment corresponding to the edge of the first surface of the target object in the camera coordinate system.

In some embodiments, as shown in FIG. 3B, the step 104 includes steps 1041-1043.

The step 1041 includes performing plane fitting based on the point cloud data of the region image to acquire the plane information of a target plane where the first surface of the at least one target object is located.

When the at least one target object includes the target objects, the target objects defines first surfaces and target planes corresponding to the first surfaces of the target objects. The target planes are planes where the first surfaces of the target objects are located. The point cloud data includes the coordinate information of point clouds corresponding to the first surfaces of the target objects. The coordinate information of the point clouds is plane-fitted by using a least squares method to acquire a normal vector of each of the first surfaces of the target objects and a plane equation of each of the target planes where the first surfaces of the target objects are located.

In some optional embodiments, a normal vector of each of the first surfaces of the target objects is first determined by using the coordinate information of the corresponding point cloud, and then the plane equations of the plane where each of the first surfaces of the target objects is located is determined based on each normal vector. Since three non-collinear points determine a unique plane, at least three non-collinear points in each of the point clouds are selected from the point cloud data, and two vectors are constructed based on the coordinate information of the at least three non-collinear points in each of the point clouds. Then, the normal vector of the plane where each of the point clouds is located is acquired by calculating a cross product of the two vectors thereof. Then, one of the point clouds is selected, and based on the coordinate information and the normal vector of the one of the point clouds, a plane equation is constructed by using the point normal equation, and the plane equation is configured as the plane information of the target plane where the first surfaces of a corresponding one of the target objects is located.

The step 1042 includes determining coordinates of corner point regions of the region image based on the point cloud data of the region image.

Since the corner point regions are commonly located at characteristic positions on the plane, such as regions around edge intersections or regions where curvature changes significantly, it is understood that there are many corner points located within each of the corner point regions. Namely, the corner points around and/or overlap edge intersections and corner points where curvature changes significantly consiste each of the corner point regions. Therefore, the corner point regions are detected in the target planes where the first surfaces of the target objects are located through curvature analysis or edge detection algorithms, thereby acquiring the corner point coordinates of the corner points in the corner point regions.

In some embodiments, as shown in FIG. 3D, the step 1042 is achieved by steps 421-422.

The step 421 includes determining target point clouds from the point cloud data of the region image. The target point clouds are point clouds corresponding to the corner point regions of the first surface of the at least one target object.

Taking one target object as an example, the target point cloud is the point cloud corresponding to the corner point regions of the first surface of the target object. Since the corner point regions are generally located at characteristic locations on the plane, such as the edge intersections or the points with significant curvature changes, the curvature of each of the point clouds within the neighborhood is determined. The point clouds each with the curvature greater than a threshold are determined as the target point clouds correspond to the corner point regions.

The step 422 includes when a quantity of the target point clouds is greater than a first predetermined value, determining each of the corner point coordinates of the corner point regions based on coordinates of each of the target point clouds.

Taking one target object as an example, the first predetermined value is predetermined based on a shape of the first surface of the target object. The first predetermined value is calculated by subtracting 1 from a minimum number of the corner point regions required to determine positions of all corner point regions of the first surface of the target object. For example, when the first surface of the target object is a rectangle, a rectangle has four corner point regions. On the premise that the coordinates of three corner point regions are acquired, the coordinates of the corner points of all corner point regions are determined. Therefore, the minimum number of the corner point regions required is 3, and the first predetermined value is 2.

For instance, taking the first surface of the target object is the rectangle as an example, it is determined that the first predetermined value is 2. When the quantity of target point clouds is greater than 2, it indicates that the coordinates of 3 or 4 corner point regions are known. When the coordinates of the 4 corner point regions are known, the coordinates of all corner point regions are directly acquired based on the coordinates of the target point clouds. When the coordinates of the 3 corner point regions are known, mathematical deduction is performed based on the coordinates of the 3 corner point regions to acquire the coordinates of a fourth corner point, thereby acquiring the coordinates of all corner point regions of the first surface of the target object. For example, when three corner points A (1, 1, 0), B (3, 1, 0), and C (3, 3, 0) are known (e.g., the corner point A is located in a first corner point region, the corner point B is located in a second corner point region, and the corner point C is llocated in a third corner point region), since the Z coordinates of the corner points A and B are the same, X coordinates of the corner points B and C are the same, and Y coordinates of the corner points C and A are the same, it is determined that the rectangle is on a XY plane. Therefore, an X coordinate of the fourth corner point D is the same as an X coordinate of the corner point A, and a Y coordinate of the fourth corner point D is the same as that of the corner point C. Therefore, the coordinates of a corner pont D located in a fourth corner point region D are (1, 3, 0).

In the embodiment, taking one target object as an example, the target point clouds are determined from the point cloud data. When the quantity of the target point clouds is greater than the first predetermined value, the corner point coordinates of each of the corner points of the corner point regions are determined based on the coordinates of the target point clouds. In this way, the plane information is determined through plane fitting, and when the quantity of the target point clouds is greater than the first predetermined value, the corner point coordinates of each of the corner point regions are directly determined. Therefore, a calculation method is simplified and the convenience and efficiency of determining the corner point coordinates is improved.

In actual application scenarios, due to limitations such as a field of view (FOV) of the camera, environmental factors, and the color of the target object, the point cloud data for the first surface of the target object may be incomplete, and the quantity of the target point clouds may be equal to or even less than the first predetermined value.

In some embodiments, when the quantity of the target point clouds is equal to the first predetermined value, the corner point coordinates of the corner point regions are determined through the following process: acquiring size information of the at least one target object; generating a first supplementary point cloud based on the target point clouds and the size information; and determining the corner point coordinates of the corner point regions based on the coordinates of the target point clouds and the coordinates of the first supplementary point cloud.

The size information refers to a series of metric data configured to describe a size of an object, generally including a length, a width, a height (for a three-dimensional object) or a diameter, and a radius (for a circular object) of the object. Taking one target object as a cuboid as an example, the size information is generally expressed in length, width, and height, and units thereof may be centimeters, inches, meters, etc. The first supplementary point cloud refers to point clouds corresponding to corner point regions that were not originally included in the point cloud data when the quantity of the target point clouds is equal to the first predetermined value. Therefore, the target point cloud and the first supplementary point cloud jointly form all of the corner point regions of the first surface. Therefore, the coordinates of all corner point regions can be determined based on the coordinates of the target point cloud and the coordinates of the first supplementary point cloud.

Taking an example that the first surface of one target object is the rectangle and the first predetermined value is 2 for further illustration, when the number of target point clouds is 2, the coordinates of the two corner point regions are known. In this case, the two corner point regions must be located on the same edge. When the size information of the target object is known, a length and a width of the first surface of the target object are determined based on the size information. Thus, by mathematically deducing the coordinates of the two corner point regions of the rectangle, combined with the length and the width of the rectangle, the coordinates of all of the corner points of the corner point regions are acquired.

In some embodiments, the size information includes the length and the width of the first surface of the target object, and the first supplementary point cloud is generated by the following process: determining a distance between the target point clouds; and when a difference between the distance and the width of the first surface is less than a second predetermined value, determining coordinates of the first supplementary point cloud based on the coordinates of the target point clouds and the length of the first surface; or when the difference between the distance and the length of the first surface is less than the second predetermined value, determining the coordinates of the first supplementary point cloud based on the coordinates of the target point clouds and the width of the first surface.

The distance between the target point clouds refers to an actual distance between the corner points corresponding to the target point clouds. A coordinate distance between the target point clouds is determined first, and then the actual distance is determined based on a correspondence between the coordinate distance and the actual distance. As mentioned above, the corner point regions corresponding to the two target point clouds must be two corner point regions located on the same edge, so the actual distance between the target point clouds conforms to the length or the width of the first surface. Since an actual length or an actual width of the first surface may have an error with the distance between the two target point clouds, a second predetermined value is set based on the error, such as 0.5 cm, 7 mm, etc. When the difference between the distance and the width of the first surface is less than the second predetermined value, it means that the two target point clouds correspond to two corner point regions located on a width edge of the first surface. At this time, the coordinates of the first supplementary point cloud are calculated based on the coordinates and the length of the target point clouds. When the difference between the distance and the length of the first surface is less than the second predetermined value, it means that the two target point clouds correspond to two corner point regions located on a length edge of the first surface. At this time, the coordinates of the first supplementary point cloud are calculated based on the coordinates and the width of the target point clouds.

For example, the first surface of the target object has the length of 60 cm and the width of 40 cm. The coordinates of two corner points in the target point clouds are A (10, 10, 0) and B (51, 10, 0). Specifically, the corner point A is a point in the first corner point region, and the corner point B is the point in the second corner point region. The second predetermined value is 2 cm. For ease of illustration, take an example where the coordinate distance between the two target point clouds is equal to the actual distance. In this case, the distance between the two corner points A and B is 41 cm, and the difference between the distance and width of the first surface is less than 2 cm. The two corner points in the target point clouds are respectively located in the two corner point regions on the width edge of the rectangle. Through mathematical deduction, the coordinates of corresponding coner points in the first supplementary point cloud are determined to be a corner point C (10, 70, 0) and a corner point D (51, 70, 0).

In the embodiment, when the quantity of the target point clouds is equal to a first predetermined value, the size information of the at least one target object is acquired, and the first supplementary point cloud is generated based on the target point clouds and the size information to determine the corner point coordinates of the corner point regions. Specifically, when the size information includes the length and the width of the first surface, the distance between the target point clouds is determined. When the difference between the distance and the width of the first surface of the at least one target object is less than the second predetermined value, the coordinates of the first supplementary point cloud are determined based on the coordinates and the length of the target point clouds. When the difference between the distance and the length of the first surface of the at least one target object is less than the second predetermined value, the coordinates of the first supplementary point cloud are determined based on the coordinates and the width of the target point clouds. In this way, by determining the coordinates of the first supplementary point cloud, originally missing corner point clouds in the point cloud data are supplemented, thereby enriching the point cloud data and improving the reliability and accuracy of the determination of the pose information.

In some embodiments, when the quantity of the target point clouds is less than the first predetermined value, the corner point coordinates of the corner point regions are determined by the following process: generating a second supplementary point cloud located within the target plane based on the point cloud data; adding the second supplementary point cloud to the point cloud data to acquire updated point cloud data; and determining the corner point coordinates of the corner point regions based on the target point clouds and the updated point cloud data.

The embodiment still takes the target object includes the first surface being a rectangle and the first predetermined value being 2 as an example: when the quantity of the target point clouds is less than 2, it means that only one corner point region of the rectangle is known. At this time, the point cloud data is seriously missing, so the point cloud data needs to be supplemented. Specifically, the target plane refers to the plane where the first surface of the target object is located. The second supplementary point cloud refers to a point cloud corresponding to any position in the first surface that was not originally included in the point cloud data when the quantity of target point clouds is less than the first predetermined value. The updated point cloud data includes most of the point clouds of the first surface, as well as point clouds corresponding to all corner point regions of the first surface of the target object. Therefore, based on the target point cloud and the updated point cloud data, the corner point coordinates of the corner point regions are determined.

As shown in FIG. 3E, the second supplementary point cloud located within the target plane is generated through steps 201-204.

The step 201 includes determining a center point based on the coordinates of each of point clouds in the point cloud data.

The center point of the point cloud data refers to a center point of the coordinates of all of the point clouds. A clustering algorithm is applied to determine a place with the most dense point cloud coordinates as the center point, or an average value of the coordinates of all of the point clouds is calculated as the center point.

The step 202 includes generating, based on the center point, candidate point clouds disposed at predetermined intervals and located within the target plane.

Starting from the center point, the candidate point clouds are generated uniformly within the target plane at predetermined intervals along different directions. The predetermined intervals determine the distances of the candidate point clouds and are determined according to actual needs. The smaller the predetermined intervals, the more candidate point clouds are generated. For example, when the center point is (1, 1, 0), each of the predetermined intervals is 1 unit, and the target plane is the XY plane (z=0), the candidate point clouds are generated by 5*5, meaning there are five candidate point clouds in each of directions from the center point. In this case, taking the x-coordinate of the center point as a reference, two points are generated to a left thereof and rest two points are generated to a right thereof, with an interval between each two adjacent points being i unit. Similarly, taking the y-coordinate of the center point as a reference, two points are generated upward and the other two points are generated downward, and the interval between each two adjacent points is 1 unit. Generated points on the x-axis and the y-axis are then combined to form a 5×5 grid, which results in a grid with 25 points. Each of the points has a z-coordinate of 0 and a distance between each two adjacent points is 1 unit. The 25 points constitute the candidate point clouds.

The step 203 includes projecting each of the candidate point clouds into the image to be recognized to acquire projected pixel points.

The candidate point clouds in the three-dimensional space are projected onto the image to be recognized (i.e., a two-dimensional image) by using the intrinsic parameters and extrinsic parameters of the camera. Specifically, the coordinates of the candidate point clouds are combined with the intrinsic parameters and extrinsic parameters of the camera, and matrix operations are performed to determine projected positions of corresponding pixel points in the image to be recognized, yielding the projected pixel points. The intrinsic parameters of the camera include the focal length and principal point coordinates, which describe properties of the camera. The extrinsic parameters include a rotation and a translation of the camera, which describe the position and an orientation of the camera in a specific environment.

The step 204 includes when the projected pixel points are located within the region image, determining the candidate point clouds as the second supplementary point cloud.

When the projected pixel points of the candidate point clouds are within the region image in the image to be recognized, then the candidate point clouds are determined as the second supplementary point cloud, otherwise, the candidate point clouds are deleted. Specifically, a coordinate range corresponding to a range of the region image is determined first, and then coordinate information of each of the projected pixel points of the candidate point clouds after projection in the image to be recognized is determined, and it is determined whether each coordinate information meets the coordinate range. When each coordinate information meets the coordinate range, it means that the projected pixel points of the candidate point cloud after projection are within the range of the region image.

In the embodiment, taking one target object as the example, when the quantity of target point clouds is less than the first predetermined value, the second supplementary point cloud located within the target plane is generated based on the point cloud data, and the second supplementary point cloud is added to the point cloud data to acquire the updated point cloud data, thereby determining the coordinates of the corner point regions. When generating the second candidate point cloud, the center point of the point clouds is first determined, and then the candidate point clouds are generated and projected at predetermined intervals based on the center point. The projected pixel points of the candidate point clouds located within the region image are determined as the second supplementary point cloud. In this way, even when point cloud data is severely missing, the coordinates of the corner point regions of the first surface of the target object are determined by supplementing the point cloud data with the second supplementary point cloud, thereby improving the reliability of the pose determination method.

The step 1043 includes determining the boundary information of the first surface of the at least one target object based on the corner point coordinates.

The corner point coordinates of the corner point regions directly serve as the boundary information of the at least one target object, or the line segment equations respectively corresponding to edges of the first surface of the at least one target object are determined from the corner point coordinates of the corner point regions, and the line segment equations serve as the boundary information.

In the embodiment, plane fitting is performed based on the point cloud data to acquire the plane information of the target plane where the first surface of the at least one target object lies. The corner point coordinates of each of the corner point regions are determined based on the point cloud data. Finally, the boundary information is determined based on the corner point coordinates of the corner point regions. The boundary information allows for rapid and accurate determination of the spatial information of the first surface of the at least one target object, facilitating determination of the pose information of the target object based on the plane and boundary information of the first surface, thereby improving the efficiency and accuracy of determining the pose of the at least one target object.

The step 105 includes determining pose information of the at least one target object based on the plane information and the boundary information.

The pose information describes a position and an orientation of the at least one target object within the specific environment. Through the plane information and the boundary information, the position and the orientation of the first surface of the at least one target object in space is determined. Since the first surface is the top surface of the at least one target object, the position and orientation of the first surface of the at least one target object in space are configured to determine the overall pose information of the at least one target object.

In some embodiments, the pose information of the at least one target object is determined by performing the following process: acquiring size information of the at least one target object; determining position information of second surfaces of the at least one target object based on the plane information, the boundary information, and the size information of the at least one target object; and determining the plane information, the boundary information, and the position information of the second surfaces as the pose information.

The second surfaces include all surfaces of the at least one target object other than the first surface.

Taking one target object as the cuboid as an example, the first surface thereof is the top surface of the cuboid, and the second surfaces include a front surface, a rear surface, a bottom surface, a left surface, and a right surface of the cuboid. When the plane information and the boundary information of the first surface of the target object are acquired, the position information of the second surfaces of the cuboid is derived based on the size information and a shape characteristics of the target object. Then, the plane information and the boundary information of the first surface, and the position information of the second surfaces are jointly determined as the pose information of the target object. In this way, information contained in the pose information is enriched, the accuracy of the pose information is improved, and other operations such as moving the target object is facilitated based on the pose information.

In the embodiments of the present disclosure, the image to be recognized and the depth image corresponding to the image to be recognized are acquired, where the image to be recognized includes the at least one target object. Then, the region image corresponding to the first surface of the at least one target object is determined from the image to be recognized, the point cloud data of the region image is determined based on the region image and the depth image, the plane information and the boundary information of the first surface of the at least one target object are determined based on each point cloud data, and the pose information of the at least one target object is determined based on the plane information and the boundary information. Specifically, by determining the point cloud data of the region image based on the region image and the depth image, the point cloud data is enriched. The point cloud data is enriched to improve the reliability and accuracy of determining the plane information and the boundary information of the first surface of the at least one target object, thereby improving the reliability and accuracy of determining the pose information. Moreover, by determining the plane information and the boundary information of the first surface of the at least one target object through plane fitting, spatial information of the first surface of the at least one target object is accurately recognized, thereby improving the accuracy of determining the pose information of the at least one target object. In addition, since the pose information is determined only by the first surface of the at least one target object in the present disclosure, integrity requirements for the image to be recognized are low, which expands the application scope of the pose determination method. Therefore, the embodiments of the present disclosure improve the reliability and accuracy of pose determination and improve the application scope of the pose determination method.

In some embodiments, as shown in FIG. 3F, after the step of determining the pose information of the at least one target object, the at least one target object is moved through steps 301-305.

The step 301 includes determining target gripping positions of the at least one target object based on the pose information, and determining, based on the target gripping positions, joint movement information of a target device configured to grip one target device of the at least one target object.

The target device is an intelligent handling robot configured to grip and move the at least one target object. The target device includes joint structures and gripping structures. The joint structures control movements of the gripping structures, while the gripping structures grip one target object at a time. The target gripping positions are the optimal gripping positions for the gripping structures when the target device grips the target object. The joint movement information is configured to control the joint structures of the target device, enabling the gripping structures to move to the target gripping positions and grip the target object.

The step 302 includes controlling, based on the joint movement information, the target device to grip the one target object.

The joint structures of the target device are controlled by the joint movement information, so that the gripping structures of the target device are able to move to the target gripping positions and grip the target object.

The step 303 includes acquiring a target position of the one target object and a current position of the target device.

The target position of the at least one target object is a target location that the target device needs to move to, and the current position of the target device is a current location of the target device. The target position of the target device is predetermined, and the current position of the target device is acquired in real time by a location sensor.

The step 304 includes performing path planning based on the target position of the one target object and the current position of the target device to acquire a movement path of the target device.

The current position of the target device is configured as a starting point of the target device and the target position of the target device is configured as an end point of the target device. On the premise, the movement path is a path from the starting point to the end point and is generated through path planning. A planning process of the path planning is designed to minimize a travel distance, avoid unnecessary turns, and steer clear of potential obstacles.

The step 305 includes controlling the target device to move based on the movement path of the target device, and when the target device reaches the target position, controlling the target device to perform a release action of placing the one target object in the target position.

The target device is controlled to move along the movement path from the current position until the target device reaches the target position. After reaching the target position, the target device performs a release action, and the gripping structures releases the force applied to the target object, allowing the target object to be naturally placed at the target position, thus completing the handling of the target object.

In the embodiment, the target gripping positions of the at least one target object are determined based on the pose information, the joint movement information of the target device configured to grip the at least one target object is determined based on the target gripping positions, the target device is controlled to grip the at least one target object based on the joint movement information, the target position of the at least one target object and the current position of the target device are acquired, and path planning is performed based on the target position of the at least one target object and the current position of the target device to acquire the movement path of the target device; and the target device is controlled to move based on the movement path of the target device. When the target device reaches the target position, controlling the target device to perform the release action of placing the at least one target object in the target position. In this way, by gripping the target object through the pose information, a success rate of the target device gripping the at least one target object is improved without damage to the at least one target object. Further, an automation degree and a success rate of moving the at least one target object is improved.

The following describes an exemplary application of one embodiment of the present disclosure in a practical application scenario. The embodiment is applied to control a robot to move boxes indoors and outdoors.

When handling a box, the robot needs to use RGB and depth images captured by sensors to determine the pose of the box. However, due to inherent sensor limitations, when the camera is too close to the boxes or when the boxes are exposed to sunlight, significant depth information on the boxes may be missing, resulting in inaccurate or even impossible pose determination. To solve the problem, the embodiment of the present disclosure, taking into account the prior knowledge that specific structures and sizes of the boxes are known in practical application scenarios, provides a point cloud completion and pose determination algorithm based on the known structures of the boxes. The point cloud completion and pose determination algorithm utilizes limited depth information on the boxes to complete missing depth information and determine the pose of the boxes.

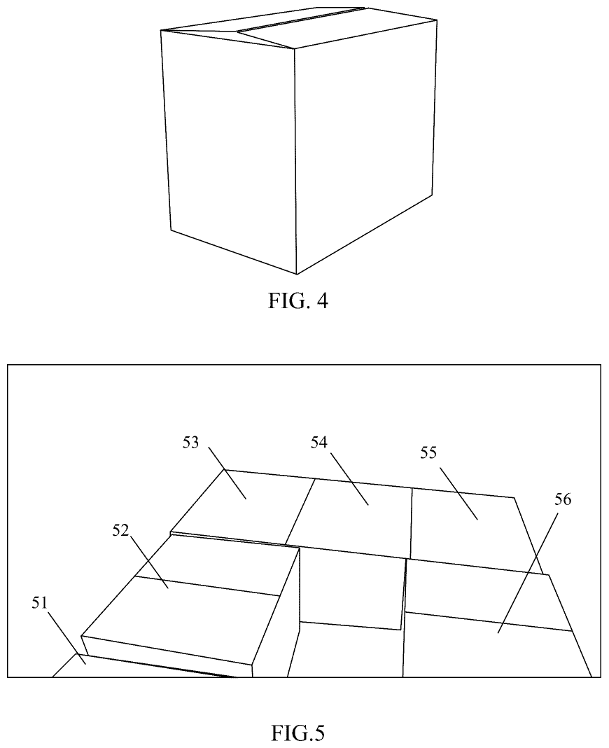

The present disclosure takes an example that the at least one target object includes boxes for further illustration. Each of the boxes is a cardboard box and is a cuboid as shown in FIG. 4. To determine the pose of the boxes, a camera is fixedly disposed on a head of the robot. When approaching the boxes, the robot lowers the head slightly to ensure the boxes are within a imaging range of the camera.

In practical application scenarios, since the FOV of the camera is limited, the top surfaces (i.e., the first surfaces) of the boxes may not be complete within an image captured by the camera (i.e., the image to be recognized). As shown in FIG. 5, there are six boxes, such as a: box 51, a box 52, a box 53, a box 54, and a box 55. The top surface of box 51 and the top surface of the box 55 are incomplete.

When estimating the pose of the boxes relative to the robot, it is necessary to find the boxes in the image to be recognized and then determine the pose thereof. Therefore, a box top segmentation network needs to be trained. In sample images each containing one or more boxes, the top surfaces of the boxes are annotated one by one as instance masks. By annotating batches of sample images a training set is constructed. The training set is then used to train the box top segmentation network to generate a box top segmentation model. The box top segmentation model is able to segment the top surface of each of the boxes in the image to be recognized.

After acquiring the region image of the top surface of each of the boxes in the image to be recognized, the pose of each of the boxes in the image to be recognized is determined. The present disclosure takes an example of determining the pose of one box for further illustration.

Based on the region image of the box, the depth information of the box in the depth image is acquired, and combined with the intrinsic parameters of the camera, the point cloud data of the top surface of the box in the camera coordinate system is acquired. When the point cloud data of the top surface of the box is relatively complete, a plane equation and a boundary of the top surface of the box are fitted by a rectangular plane fitting method (as long as at least two corner point regions of the box are exposed, a normal vector and corner point coordinates of the plane in the camera coordinate system are determined). In the case where only two corner point regions of the box are exposed, the coordinates of the remaining two corner point regions are inferred based on the known size information of the box.

In practice, when the robot moves the box, the camera may be too close to the box (the box is disposed below the imaging range of the camera), the working environment may be outdoors (the depth information acquired from the camera is lost due to sunlight interference), or the box may be black (severe light absorption leads to loss of the depth information). These factors may cause significant loss of the point cloud data of the top surface of the box, making it impossible to fit the plane equation and the boundary of the top surface of the box by the rectangular plane fitting method. The embodiment of the present disclosure provides a point cloud data completion method that is able to effectively complete the missing point cloud data. The following are specific steps of the point cloud data completion method.

Based on current point cloud data, plane fitting is performed to acquire the normal vector of the top surface of the box in the camera coordinate system and a center point of all point clouds (a difference from the rectangular plane fitting method is that the center point of all point clouds is not necessarily a center point of the top surface of the box).

Based on any one of the point clouds and the normal vector, the plane where the top surface of the box is located, i.e., the target plane, is determined. Then, dense candidate point clouds disposed at predetermined intervals are generated within the target plane.

The candidate point clouds are back-projected onto the image to be recognized by using the extrinsic parameters and the intrinsic parameters of the camera. When one of the candidate point clouds falls within the region of the top surface of the box after back-projection, the one of the candidate point clouds is considered to be one of the point clouds on the top surface of the box, that is, one point cloud of the second supplementary point cloud. Then, the one of the candidate point clouds is retained in a set A; otherwise, the one of the candidate point clouds is discarded.

Through the point cloud set A, the plane equation and boundary of the upper surface of the box are acquired by the rectangular plane fitting method, and then 3D pose information of the box is acquired by combining the size information of the box.

In the embodiment, the plane equation and boundary of the upper surface of the box are acquired by the rectangular plane fitting method, and then combining the known size of the box to determine the 3D pose of the box. The method, through point cloud completion, solves the problem of being unable to use the rectangular plane fitting method to determine the plane equation and boundary of the upper surface of the box when the point clouds are severely missing. Therefore, the embodiment of the present disclosure improves the reliability and accuracy of pose determination.

The present disclosure further describes an exemplary structure of a posture determination device 455 provided in one embodiment of the present disclosure. The posture determination device 455 is a software module. In some embodiments, as shown in FIG. 2, software modules stored in the posture determination device 455 of the memory 450 include an acquisition module 4551 and a determination module 4552.

The acquisition module 4551 is configured to acquire an image to be recognized and a depth image corresponding to the image to be recognized. The image to be recognized includes at least one target object.

The determination module 4552 is configured to determine, from the image to be recognized, a region image corresponding to a first surface of the at least one target object. The determination module 4552 is configured to determine point cloud data of the region image based on the region image and the depth image. The determination module 4552 is configured to determine plane information and boundary information of the first surface of the at least one target object based on each point cloud data. The determination module 4552 is further configured to determine pose information of the at least one target object based on the plane information and the boundary information.

In some embodiments, the determination module 4552 is further configured to acquire position information of the region image in the image to be recognized. The determination module 4552 is configured to acquire depth information of the region image from the depth image based on the position information. The depth information of the region image includes depth values of pixel points in the region image. The determination module 4552 is configured to determine coordinate information of each of the pixel points in a camera coordinate system based on each of the depth values of the region image and intrinsic parameters of a camera. The determination module 4552 is further configured to determine the point cloud data of the region image based on each coordinate information.

In some embodiments, the determination module 4552 is further configured to perform plane fitting based on the point cloud data of the region image to acquire the plane information of a target plane where the first surface of the at least one target object is located. The determination module 4552 is further configured to determine coordinates of corner point regions of the region image based on the point cloud data of the region image. The determination module 4552 is further configured to determine the boundary information of the first surface of the at least one target object based on the corner point coordinates.

In some embodiments, the determination module 4552 is further configured to determine target point clouds from the point cloud data of the region image, wherein the target point clouds are point clouds corresponding to the corner point regions of the first surface of the at least one target object. When a quantity of the target point clouds is greater than a first predetermined value, the determination module 4552 is further configured to determine each of the corner point coordinates of the corner point regions based on coordinates of each of the target point clouds.

In some embodiments, when the quantity of the target point clouds is equal to the first predetermined value, the determination module 4552 is further configured to acquire size information of the at least one target object, generate a first supplementary point cloud based on the target point clouds and the size information, and determine the corner point coordinates of the corner point regions based on the coordinates of the target point clouds and the coordinates of the first supplementary point cloud.

In some embodiments, the determination module 4552 is further configured to determine a distance between the target point clouds. When a difference between the distance and the width of the first surface is less than a second predetermined value, the determination module 4552 is further configured to determine coordinates of the first supplementary point cloud based on the coordinates of the target point clouds and the length of the first surface. Alternatively, when the difference between the distance and the length of the first surface is less than the second predetermined value, the determination module 4552 is further configured to determine the coordinates of the first supplementary point cloud based on the coordinates of the target point clouds and the width of the first surface.

In some embodiments, when the quantity of the target point clouds is less than the first predetermined value, the determination module 4552 is further configured to generate a second supplementary point cloud located within the target plane based on the point cloud data, add the second supplementary point cloud to the point cloud data to acquire updated point cloud data, and determine the corner point coordinates of the corner point regions based on the target point clouds and the updated point cloud data.

In some embodiments, the determination module 4552 is further configured to determine a center point based on the coordinates of each of point clouds in the point cloud data. The determination module 4552 is further configured to generate, based on the center point, candidate point clouds disposed at predetermined intervals and located within the target plane. The determination module 4552 is further configured to project each of the candidate point clouds into the image to be recognized to acquire projected pixel points. When the projected pixel points are located within the region image, the determination module 4552 is further configured to determine the candidate point clouds as the second supplementary point cloud.

In some embodiments, the determination module 4552 is further configured to acquire size information of the at least one target object. The determination module 4552 is further configured to determine position information of second surfaces of the at least one target object based on the plane information, the boundary information, and the size information of the at least one target object. The second surfaces include all surfaces of the at least one target object other than the first surface. The determination module 4552 is further configured to determine the plane information, the boundary information, and the position information of the second surfaces as the pose information.

In some embodiments, the determination module 4552 is further configured to determine target gripping positions of the at least one target object based on the pose information. The determination module 4552 is further configured to determine, based on the target gripping positions, joint movement information of a target device configured to grip one target device of the at least one target object. The determination module 4552 is further configured to control, based on the joint movement information, the target device to grip the one target object. The determination module 4552 is further configured to acquire a target position of the one target object and a current position of the target device. The determination module 4552 is further configured to perform path planning based on the target position of the one target object and the current position of the target device to acquire a movement path of the target device; The determination module 4552 is further configured to control the target device to move based on the movement path of the target device. When the target device reaches the target position, the determination module 4552 is further configured to control the target device to perform a release action of placing the one target object in the target position.

The embodiments of the present disclosure provide a computer program product. The computer program product includes a computer program or computer-executable instructions, and the computer program or the computer-executable instructions are stored in a computer-readable storage medium. The at least one processor of the electronic device reads the computer-executable instructions from the computer-readable storage medium, and the at least one processor executes the computer-executable instructions, so that the electronic device performs the pose determination method of the embodiments of the present disclosure.

The embodiments of the present disclosure further provide the computer-readable storage medium. The computer-readable storage medium includes the computer-executable instructions stored therein or the computer program stored therein. The computer-executable instructions or the computer program is executed by at least one processor to implement the pose determination method according to the embodiments of the present disclosure.

In some embodiments, the computer-readable storage medium may be the memory such as the RAM, the ROM, the flash memory, a magnetic surface memory, an optical disk, a CD-ROM; or other devices including one or any combination of the above memories.

In some embodiments, the computer-executable instructions are in the form of a program, a software, a software module, a script, or codes, written in any form of programming language (including compiled or interpreted languages, or declarative or procedural languages), and are deployed in any form, including being deployed as an independent program or as a module, a component, a subroutine, or other unit suitable for use in a computing environment.

As an example, the computer-executable instructions may, but not necessarily, correspond to a file in a file system. Instead, the computer-executable instructions are stored as parts of a file storing other programs or data. For instance, the computer-executable instructions are stored in one or more scripts in a hypertext markup language (HTML) document, in a single file dedicated to the program in question, or are stored in multiple collaborative files (e.g., files storing one or more modules, subroutines, or code portions).

As an example, the computer-executable instructions are deployed to be executed on the electronic device, or on a plurality of electronic devices located at one location. Alternatively, the computer-executable instructions are executed on electronic devices disposed at multiple locations and interconnected by a communication network.

In the embodiments of the present disclosure, the image to be recognized and the depth image corresponding to the image to be recognized are acquired, where the image to be recognized includes the at least one target object. Then, the region image corresponding to the first surface of the at least one target object is determined from the image to be recognized, the point cloud data of the region image is determined based on the region image and the depth image, the plane information and the boundary information of the first surface of the at least one target object are determined based on each point cloud data, and the pose information of the at least one target object is determined based on the plane information and the boundary information. Specifically, by determining the point cloud data of the region image based on the region image and the depth image, the point cloud data is enriched. The point cloud data is enriched to improve the reliability and accuracy of determining the plane information and the boundary information of the first surface of the at least one target object, thereby improving the reliability and accuracy of determining the pose information. Moreover, by determining the plane information and the boundary information of the first surface of the at least one target object through plane fitting, spatial information of the first surface of the at least one target object is accurately recognized, thereby improving the accuracy of determining the pose information of the at least one target object. In addition, since the pose information is determined only by the first surface of the at least one target object in the present disclosure, integrity requirements for the image to be recognized are low, which expands the application scope of the pose determination method. Therefore, the embodiments of the present disclosure improve the reliability and accuracy of pose determination and improve the application scope of the pose determination method.

The above description is only optional embodiments of the present disclosure and is not intended to limit the protection scope of the present disclosure. Any modifications, equivalent substitutions, improvements, etc. made within the spirit and scope of the present disclosure are included in the protection scope of the present disclosure.

What is claimed is:

1. A pose determination method, comprising steps:
acquiring an image to be recognized and a depth image corresponding to the image to be recognized, wherein the image to be recognized comprises at least one target object;
determining, from the image to be recognized, a region image corresponding to a first surface of the at least one target object;
determining point cloud data of the region image based on the region image and the depth image;
determining plane information and boundary information of the first surface of the at least one target object based on each point cloud data; and
determining pose information of the at least one target object based on the plane information and the boundary information.

2. The pose determination method according to claim 1, wherein the step of determining the point cloud data of the region image based on the region image and the depth image comprises steps:
acquiring position information of the region image in the image to be recognized;
acquiring depth information of the region image from the depth image based on the position information, the depth information of the region image comprises depth values of pixel points in the region image;
determining coordinate information of each of the pixel points in a camera coordinate system based on each of the depth values of the region image and intrinsic parameters of a camera; and
determining the point cloud data of the region image based on each coordinate information.

3. The pose determination method according to claim 1, wherein the step of determining the plane information and the boundary information of the first surface of the at least one target object based on each point cloud data comprises steps:
performing plane fitting based on the point cloud data of the region image to acquire the plane information of a target plane where the first surface of the at least one target object is located;
determining coordinates of corner point regions of the region image based on the point cloud data of the region image; and
determining the boundary information of the first surface of the at least one target object based on the corner point coordinates.

4. The pose determination method according to claim 3, wherein the step of determining the corner point coordinates of the corner point regions of the region image based on the point cloud data of the region image comprises steps:
determining target point clouds from the point cloud data of the region image, wherein the target point clouds are point clouds corresponding to the corner point regions of the first surface of the at least one target object; and
when a quantity of the target point clouds is greater than a first predetermined value, determining each of the corner point coordinates of the corner point regions based on coordinates of each of the target point clouds.

5. The pose determination method according to claim 4, wherein the pose determination method further comprises steps:
when the quantity of the target point clouds is equal to the first predetermined value, acquiring size information of the at least one target object;
generating a first supplementary point cloud based on the target point clouds and the size information; and
determining the corner point coordinates of the corner point regions based on the coordinates of the target point clouds and the coordinates of the first supplementary point cloud.

6. The pose determination method according to claim 5, wherein the size information of the at least one target object comprises a length and a width of the first surface of the at least one target object, and the step of generating the first supplementary point cloud based on the target point clouds and the size information comprises:
determining a distance between the target point clouds; and
when a difference between the distance and the width of the first surface is less than a second predetermined value, determining coordinates of the first supplementary point cloud based on the coordinates of the target point clouds and the length of the first surface; or
when the difference between the distance and the length of the first surface is less than the second predetermined value, determining the coordinates of the first supplementary point cloud based on the coordinates of the target point clouds and the width of the first surface.

7. The pose determination method according to claim 4, wherein the pose determination method further comprises steps:
when the quantity of the target point clouds is less than the first predetermined value, generating a second supplementary point cloud located within the target plane based on the point cloud data;
adding the second supplementary point cloud to the point cloud data to acquire updated point cloud data; and
determining the corner point coordinates of the corner point regions based on the target point clouds and the updated point cloud data.

8. The pose determination method according to claim 7, wherein the step of when the quantity of the target point clouds is less than the first predetermined value, generating the second supplementary point cloud located within the target plane based on the point cloud data comprises steps:
determining a center point based on the coordinates of each of point clouds in the point cloud data;
generating, based on the center point, candidate point clouds disposed at predetermined intervals and located within the target plane;
projecting each of the candidate point clouds into the image to be recognized to acquire projected pixel points; and
when the projected pixel points are located within the region image, determining the candidate point clouds as the second supplementary point cloud.

9. The pose determination method according to claim 7, wherein the first predetermined value is predetermined based on a shape of the first surface of the at least one target object, and the first predetermined value is calculated by subtracting 1 from a minimum number of the corner point regions required to determine positions of all corner point regions of the first surface of the at least one target object.

10. The pose determination method according to claim 1, wherein the step of determining the pose information of the at least one target object based on the plane information and the boundary information comprises steps:
acquiring size information of the at least one target object;
determining position information of second surfaces of the at least one target object based on the plane information, the boundary information, and the size information of the at least one target object, wherein the second surfaces comprise all surfaces of the at least one target object other than the first surface; and
determining the plane information, the boundary information, and the position information of the second surfaces as the pose information.

11. The pose determination method according to claim 1, wherein after the step of determining the pose information of the at least one target object based on the plane information and the boundary information, the pose determination method further comprises steps:
determining target gripping positions of the at least one target object based on the pose information, and determining, based on the target gripping positions, joint movement information of a target device configured to grip one target device of the at least one target object;
controlling, based on the joint movement information, the target device to grip the one target object;
acquiring a target position of the one target object and a current position of the target device;
performing path planning based on the target position of the one target object and the current position of the target device to acquire a movement path of the target device;
controlling the target device to move based on the movement path of the target device, and when the target device reaches the target position, controlling the target device to perform a release action of placing the one target object in the target position.

12. A pose determination device, comprising:
an acquisition module; and
a determination module;
wherein the acquisition module is configured to acquire an image to be recognized and a depth image corresponding to the image to be recognized, wherein the image to be recognized comprises at least one target object;
wherein the determination module is configured to:
determine from the image to be recognized, a region image corresponding to a first surface of the at least one target object;
determine point cloud data of the region image based on the region image and the depth image;
determine plane information and boundary information of the first surface of the at least one target object based on each point cloud data; and
determine pose information of the at least one target object based on the plane information and the boundary information.

13. An electronic device, comprising:
a memory; and
a processor;
wherein the memory is configured to store computer-executable instructions or computer programs, and the processor is configured to implement the pose determination method according to claim 1 when executing the computer-executable instructions or the computer programs stored in the memory.

14. A non-transitory computer-readable storage medium, comprising:
computer-executable instructions or computer programs stored thereon,
wherein the computer-executable instructions or the computer programs are executed by a processor to implement the pose determination method according to claim 1.

15. A computer program product, comprising:
computer-executable instructions or computer programs,
wherein the computer-executable instructions or the computer programs are executed by a processor to implement the pose determination method according to claim 1.

16. A pose determination method, comprising steps:
acquiring, by a camera disposed on a robot, an image to be recognized and a depth image corresponding to the image to be recognized, wherein the image to be recognized comprises at least one target object;
determining, by a processor, from the image to be recognized, a region image corresponding to a first surface of the at least one target object;
determining, by the processor, point cloud data of the region image based on the region image and the depth image;
determining, by the processor, plane information and boundary information of the first surface of the at least one target object based on each point cloud data;
determining, by the processor, pose information of the at least one target object based on the plane information and the boundary information; and
griping one of the at least one target object and carrying the one of the at least one target object to a target position by the robot based on the pose information of the at least one target object.
